(19) United States
(12) Patent Application Publication
(10) Pub. No.: US 2023/0389696 A1
(43) Pub. Date: Dec. 7, 2023

(54) FULLY ARTICULATED EXTENDABLE WALL-MOUNTED SHELF AND METHOD FOR TRANSPORTING SAME

(71) Applicant: ZHEJIANG SHIP ELECTRONICS TECHNOLOGY CO., LTD, Ningbo (CN)

(72) Inventors: Yongping LI, Ningbo (CN); Xianwei LUO, Ningbo (CN); Jianjian HU, Ningbo (CN)

(21) Appl. No.: 18/246,474

(22) PCT Filed: Mar. 5, 2021
(86) PCT No.: PCT/CN2021/079347

§ 371 Date: Mar. 23, 2023

(30) Foreign Application Priority Data
Oct. 29, 2020 (CN) 202011176216.5

(51) Int. Cl. A47B 46/00

(52) U.S. Cl. CPC A47B 46/00

(57) ABSTRACT

Disclosed is a fully articulated extendable wall-mounted shelf, including: a back plate; first side plate capable of rotating relative to the back plate to be flush with and/or attached to the back plate, the first side plate assembly including first connecting plate, first extendable plate and first fixing plate, the first extendable plate being capable of being extendably adjusted relative to the first connecting plate, the first fixing plate being rotatably connected to the first connecting plate; and second side plate assembly capable of rotating relative to the back plate to be flush with and/or attached to the back plate, the second side plate assembly including second connecting plate, second extendable plate and second fixing plate, the second extendable plate being capable of being extendably adjusted relative to the second connecting plate, the second fixing plate being rotatably connected to the second connecting plate.

### TECHNICAL FIELD

The present invention relates to the technical field of cabinets, in particular to a fully articulated extendable wall-mounted shelf and a method for transporting the wall-mounted shelf.

### DESCRIPTION OF RELATED ART

Wall-mounted cabinets are widely used in the intelligent construction of residential quarters. In the horizontal wiring works such as corridor wiring or small integrated wiring works, wall-mounted cabinets are used generally. During installation, for a general wall-mounted cabinet, it is only required to form 2-4 wall-mounting holes at the rear of the cabinet, and then the cabinet is fixed on a wall with expansion screws or directly embedded in the wall.

This wall-mounted cabinet has the characteristics of small size, easy placement, easy installation and disassembly, easy management and anti-theft effect and can meet the needs of operators for wiring construction. However, existing wall-mounted cabinets are generally fixed, and it is difficult to adapt to network devices of different depths such as distribution frames and switches, and it is inconvenient to assemble and install the cabinets.

Generally, since a wall-mounted shelf is transported as a whole, the wall-mounted shelf occupies a large area and few wall-mounted shelves can be contained in a car. For bulk transportation of wall-mounted shelves, this will lead to high transportation costs for wall-mounted shelves. If a one-piece wall-mounted shelf is disassembled and then transported, it will result in a large amount of assembly work and troublesome assembly after the wall-mounted shelf is transported to a customer.

For example, the Patent Application CN211184593U discloses a wall-mounted cabinet, including a cabinet body, wherein four corners of the inside of the cabinet body are fixedly connected with support columns, and outer surfaces of the four support columns are each provided with a number of notches, four first through holes are formed at a middle part of a top surface of the cabinet body, four second through holes are formed at a middle part of a bottom surface of the cabinet body, and four first mounting holes are formed in a back of the cabinet body. The wall-mounted cabinet of this solution cannot adapt to network devices of different depths inside, and the installation of network devices is troublesome. During transportation, the wall-mounted cabinet takes up a lot of space, resulting in high transportation costs.

### BRIEF SUMMARY OF THE INVENTION

In view of the above-mentioned deficiencies in the prior art, the technical problem to be solved in the present invention is to provide a fully articulated extendable wall-mounted shelf with extendable adjustment, convenient transportation, low transportation cost and wide application range and a method for transporting the wall-mounted shelf.

A technical solution disclosed in the present invention to solve its technical problem is to provide a fully articulated extendable wall-mounted shelf, including:
a back plate provided with a plurality of first fixing holes;
a first side plate assembly articulated at one end of the back plate and capable of rotating relative to the back plate to be flush with and/or attached to the back plate, the first side plate assembly including a first connecting plate, a first extendable plate and a first fixing plate that are arranged in sequence, the first extendable plate being arranged on the first connecting plate and capable of being adjusted extendably relative to the first connecting plate, the first fixing plate being rotatably connected to the first connecting plate and located at an end away from the first connecting plate; and
a second side plate assembly articulated at the other end of the back plate, and capable of rotating relative to the back plate to be flush with and/or attached to the back plate, the rotation direction of the second side plate assembly being opposite to the rotation direction of the first side plate, the second side plate assembly, the first side plate assembly and the back plate defining an installation space, the second side plate assembly including a second connecting plate, a second extendable plate and a second fixing plate that are arranged in sequence, the second extendable plate being arranged on the second connecting plate and capable of being adjusted extendably relative to the second connecting plate, the second fixing plate being rotatably connected to the second connecting plate and located at an end away from the second connecting plate.

Further, the fully articulated extendable wall-mounted shelf further includes first connectors and second connectors, wherein
the first connecting plate and the first extendable plate are each provided with first through slots; the first connectors pass through the first through slots and are configured to fix the first connecting plate and the first extendable plate;
the second connecting plate and the second extendable plate are each provided with second through slots; the second connectors pass through the second through slots and are configured to fix the second connecting plate and the second extendable plate.

Further, a plurality of first through slots are formed in parallel in both the first connecting plate and the first extendable plate; a plurality of second through slots are formed in parallel in both the second connecting plate and the second extendable plate.

Further, the first side plate assembly further includes a third connecting plate, and the second side plate assembly further includes a fourth connecting plate; the third connecting plate is arranged between the back plate and the first connecting plate; the fourth connecting plate is arranged between the back plate and the second connecting plate;
wherein each of the back plate, the first connecting plate, the second connecting plate, the third connecting plate, the fourth connecting plate, the first extendable plate and the second extendable plate includes a middle plate, an upper bent plate and a lower bent plate, wherein the upper bent plate and the lower bent plate are respectively connected to the top and bottom of the middle plate.

Further, the first fixing plate is provided with a plurality of second fixing holes sequentially from top to bottom, and the second fixing plate is provided with a plurality of third fixing holes sequentially from top to bottom;
when both the first side plate assembly and the second side plate assembly are rotated to be attached to the back plate, the second fixing holes and the third fixing holes are arranged in one-to-one correspondence.

Further, the third connecting plate is fitted over the first connecting plate and detachably connected with the first connecting plate, and the first extendable plate is movably fitted over the first connecting plate;
the fourth connecting plate is fitted over the second connecting plate and detachably connected with the second connecting plate, and the first extendable plate is movably fitted over the second connecting plate.

Further, the first fixing hole includes a round hole and a waist-shaped hole penetrating through the round hole, and the diameter of the round hole is greater than the width of the waist-shaped hole.

Further, the first side plate assembly and the second side plate assembly are symmetrically connected to two ends of the back plate, and the first side plate assembly and the second side plate assembly are the same in structure.

A technical solution disclosed in the present invention to solve its technical problem is to further provide a method for transporting a fully articulated extendable wall-mounted shelf, including fixing members and the fully articulated extendable wall-mounted shelf described above. The method for transporting a fully articulated extendable wall-mounted shelf includes:
rotating the first side plate assembly relative to the back plate until the first side plate assembly is attached to the back plate;
rotating the second side plate assembly in a direction opposite to the rotation direction of the first side plate assembly until the second side plate assembly is attached to the back plate and arranging the second fixing plate and the first fixing plate opposite to each other and then folding the fully articulated extendable wall-mounted shelf up;
fixing the first fixing plate and the second fixing plate with the fixing members; and
arranging the folded fully articulated extendable wall-mount shelves on a carrier in sequence.

A technical solution disclosed in the present invention to solve its technical problem is to further provide another method for transporting a fully articulated extendable wall-mounted shelf, including the fully articulated extendable wall-mounted shelf described above. The method for transporting a fully articulated extendable wall-mounted shelf includes:
rotating the first side plate assembly relative to the back plate until the first side plate assembly is flush with the back plate;
rotating the second side plate assembly in a direction opposite to the rotation direction of the first side plate assembly until the second side plate assembly is flush with the back plate and then unfolding the fully articulated extendable wall-mounted shelf; and
arranging the unfolded fully articulated extendable wall-mount shelves on a carrier in sequence.

Compared with the prior art, the present invention at least has the following beneficial effects.

Compared with a one-piece wall-mounted shelf, this solution is a “fully articulated” solution where the third connecting plate and the back plate are articulated, the fourth connecting plate and the back plate are articulated, the first fixing plate and the first extendable plate are articulated and the second fixing plate and the second extendable plate are articulated. During transportation of the wall-mounted shelf, folding transportation can be adopted. That is, both the first side plate assembly and the second side plate assembly are rotated to be attached to the back plate, thereby highly integrating the wall-mounted shelf. In this way, the space occupied by the wall-mounted shelf is reduced, which is equivalent to completely avoiding the occupation of space for the installation space of the wall-mounted shelf. During folding transportation, the first fixing plate and the second fixing plate are fixed by the fixing members, and then the whole wall-mounted shelf is fixed, thus achieving high stability during transportation. Moreover, after the foldable wall-mounted shelf is transported to a customer, there is no need for a complicated subsequent assembly process, and it is only needed to rotate the first side plate assembly and the second side plate assembly to assemble the wall-mounted shelf. During the transportation of the wall-mounted shelf, unfolding transportation may also be adopted for freight cars of different widths. That is, both the first side plate assembly and the second side plate assembly are rotated to be flush with the back plate to reduce the space occupied by the wall-mounted shelf. Similarly, it is equivalent to completely avoiding the occupation of space for the installation space of the wall-mounted shelf, there is no need for a complicated subsequent assembly process, and it is only needed to rotate the first side plate assembly and the second side plate assembly to assemble the wall-mounted shelf.

In the present invention, the first extendable plate can be adjusted extendably relative to the first connecting plate, and the second extendable plate can be adjusted extendably relative to the second connecting plate. That is, the height of the wall-mounted shelf is adjustable. Therefore, the wall-mounted shelf can be used for installing network devices of different depths such as distribution frames and switches, thereby having a wide application scope. The overall structure of the wall-mounted shelf is also very simple. During the installation of the network devices such as distribution frames and switches, the first fixing plate and/or the second fixing plate can be opened first, so that the network devices such as distribution frames and switches can be placed in the installation space to prevent interference. After the network devices such as distribution frames and switches are installed, the size of the installation space is adjusted to realize adaption. The first connectors and the second connectors are used to respectively fix the first extendable plate and the first connecting plate, fix the second extendable plate and the second connecting plate. Then, the first fixing plate and the second fixing plate are closed, and the network devices such as distribution frames and switches are respectively fixed in the second fixing holes and the third fixing holes. In this way, the installation process is simple and convenient. The back plate, the first connecting plate, the second connecting plate, the third connecting plate, the fourth connecting plate, the first extendable plate and the second extendable plate are all configured to comprise a middle plate, an upper bent plate and a lower bent plate. In this way, the structural strength of each component is enhanced, and the overall structural strength of the wall-mounted shelf is also improved further.

### BRIEF DESCRIPTION OF THE SEVERAL VIEWS OF THE DRAWINGS

FIG. 1 shows a schematic diagram of the overall structure of a fully articulated extendable wall-mounted shelf according to the present invention;

FIG. 2 is a schematic structural diagram of the wall-mounted shelf in FIG. 1 when a first side plate assembly and a second side plate assembly are unfolded initially;

FIG. 3 is a schematic structural diagram of the wall-mounted shelf in FIG. 1 before the first side plate assembly and the second side plate assembly are unfolded completely;

FIG. 4 is an exploded view of the whole wall-mounted shelf;

FIG. 5 is a schematic structural diagram when the first side plate assembly and the second side plate assembly are rotated to be flush with a back plate;

FIG. 6 is a schematic arrangement diagram of the fully articulated extendable wall-mounted shelf according to the present invention when unfolded for transportation;

FIG. 7 is a schematic structural diagram when the first side plate assembly and the second side plate assembly are rotated to be attached to the back plate;

FIG. 8 is a schematic plan view of FIG. 7.

FIG. 9 is a schematic arrangement diagram of the fully articulated extendable wall-mounted shelf according to the present invention when folded up for transportation;

FIG. 10 shows a method for transmitting the fully articulated extendable wall-mounted shelf according to the present invention in a case of folded transportation; and

FIG. 11 shows a method for transmitting the fully articulated extendable wall-mounted shelf according to the present invention in a case of unfolded transportation.

In the figures,
1, back plate; 10, first fixing hole; 11, middle plate; 12, upper bent plate; 13, lower bent plate;
2, first side plate assembly; 20, first connecting plate; 201, first through slot; 21, first extendable plate; 22, first fixing plate; 220, second fixing hole; 23, first connector; 24, third connecting plate;
3, second side plate assembly; 30, second connecting plate; 301, second through slot; 31, second extendable plate; 32, second fixing plate; 320, third fixing hole; 33, second connector; 34, fourth connector; and installation space.

### DETAILED DESCRIPTION OF THE INVENTION

The following are specific embodiments of the present invention and further describe the technical solutions of the present invention in conjunction with the accompanying drawings, but the present invention is not limited to these embodiments.

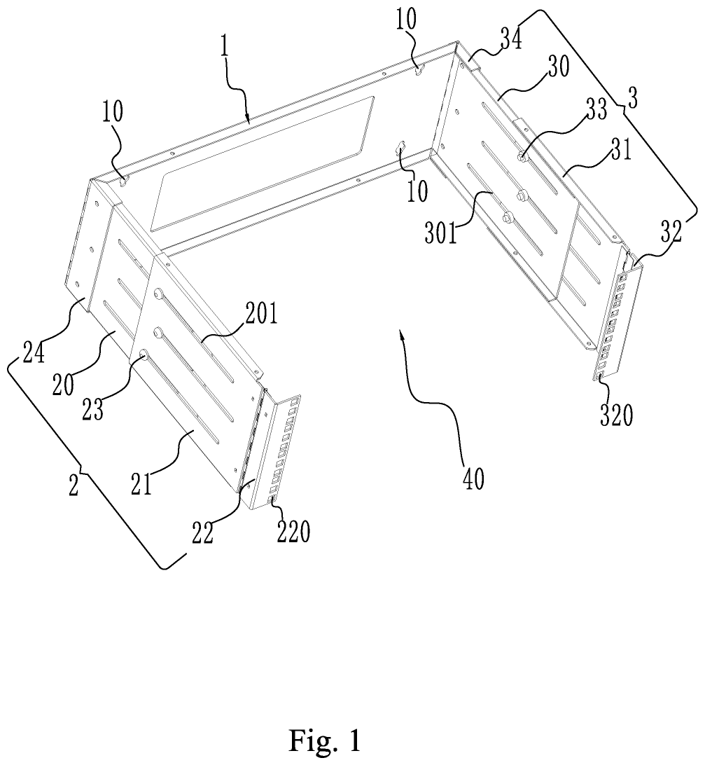

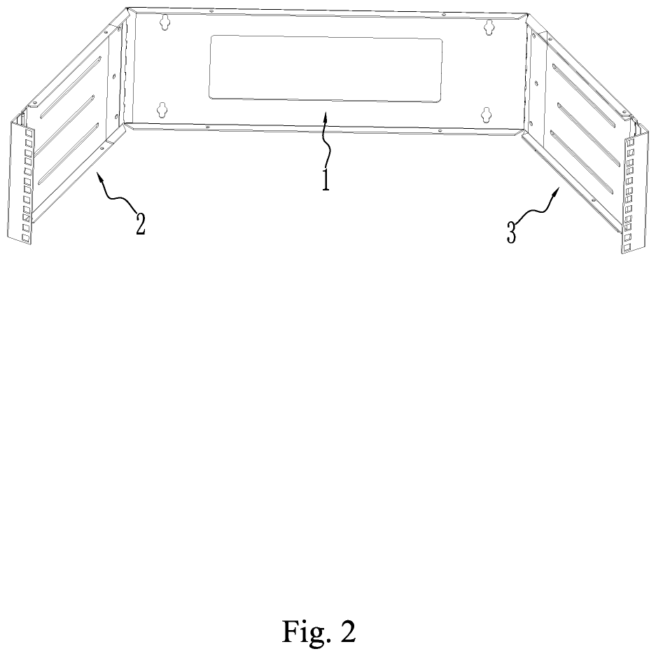

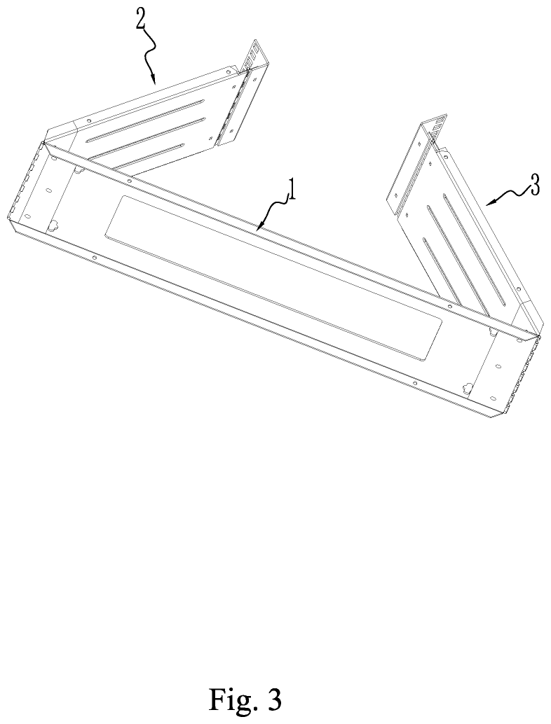

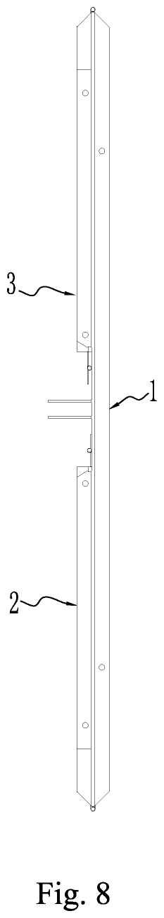

Referring to FIGS. 1-5 and 7-8, illustrated is a fully articulated extendable wall-mounted shelf, including a back plate 1 provided with a plurality of first fixing holes 10. The first fixing hole 10 includes a round hole and a waist-shaped hole penetrating through the round hole, and the diameter of the round hole is greater than the width of the waist-shaped hole. The round hole is in the middle of the waist-shaped hole and communicates with the waist-shaped hole, the round hole facilitates the insertion of an expansion screw, and the size of the waist-shaped hole is smaller than that of the round hole, which is convenient for fixing with the expansion screw.

The fully articulated extendable wall-mounted shelf further includes a first side plate assembly 2 articulated at one end of the back plate 1, specifically by a hinge, and capable of rotating relative to the back plate 1 to be flush with and/or attached to the back plate 1. The first side plate assembly 2 includes a first connecting plate 20, a first extendable plate 21 and a first fixing plate 22 that are arranged in sequence. The first extendable plate 22 is arranged on the first connecting plate 20 and capable of being adjusted extendably relative to the first connecting plate 20. The first fixing plate 21 is rotatably connected to the first connecting plate 20 and located at an end away from the first connecting plate 20. The first side plate assembly 2 further includes a third connecting plate 24 arranged between the back plate 1 and the first connecting plate 20.

The fully articulated extendable wall-mounted shelf also includes a second side plate assembly 3. The first side plate assembly 2 and the second side plate assembly 3 are symmetrically connected to two ends of the back plate 1. Moreover, the first side plate assembly 2 and the second side plate assembly 3 are the same in structure. The first side plate assembly 2 and the second side plate assembly 3 have good interchangeability and can be interchanged directly. The second side plate assembly 3 is articulated at the other end of the back plate, and capable of rotating relative to the back plate 1 to be flush with and/or attached to the back plate 1, and the rotation direction of the second side plate assembly 3 is opposite to the rotation direction of the first side plate. The second side plate assembly 3, the first side plate assembly 2 and the back plate 1 define an installation space 40. The installation space 40 is open, and after a network device is installed in the installation space 40, the installation space 40 will be fully occupied. The second side plate assembly 3 includes a second connecting plate 30, a second extendable plate 31 and a second fixing plate 32 that are arranged in sequence. The second extendable plate 31 is arranged on the second connecting plate 30 and capable of being adjusted extendably relative to the second connecting plate 30. The second fixing plate 32 is rotatably connected to the second connecting plate 30 and located at an end away from the second connecting plate 30. The second side plate assembly 3 further includes a fourth connecting plate 34 and the fourth connecting plate 34 is arranged between the back plate 1 and the second connecting plate 30. In some embodiments, the third connecting plate 24 is fitted over the first connecting plate 20 and detachably connected with the first connecting plate 20, and the first extendable plate 21 is movably fitted over the first connecting plate 20. The fourth connecting plate 34 is fitted over the second connecting plate 30 and detachably connected with the second connecting plate 30, and the first extendable plate 21 is movably fitted over the second connecting plate 30.

In use of this solution, compared with a one-piece wall-mounted shelf, this solution is a “fully articulated” solution where the third connecting plate 24 and the back plate 1 are articulated, the fourth connecting plate 34 and the back plate 1 are articulated, the first fixing plate 22 and the first extendable plate 21 are articulated and the second fixing plate 32 and the second extendable plate 31 are articulated. During transportation of the wall-mounted shelf, folding transportation can be carried out. That is, both the first side plate assembly 2 and the second side plate assembly 3 are rotated to be attached to the back plate 1, thereby highly integrating the wall-mounted shelf. In this way, the space occupied by the wall-mounted shelf is reduced and it is equivalent to completely avoiding the occupation of space for the installation space 40 of the wall-mounted shelf. During the folding transportation, the first fixing plate 22 and the second fixing plate 32 are fixed by the fixing members (not denoted in the figures); for example, the first fixing plate 22 and the second fixing plate 32 are fixed by cable ties, bolts, or the like passing through the second fixing holes 220 and the third fixing holes 320 and then the whole wall-mounted shelf is fixed and hardly deformed, thus achieving high stability during transportation. Moreover, after the foldable wall-mounted shelf is transported to a customer, there is no need for a complicated subsequent assembly process, and it is only needed to rotate the first side plate assembly 2 and the second side plate assembly 3 to assemble the wall-mounted shelf. During the transportation of the wall-mounted shelf, unfolding transportation may also be adopted for freight cars of different widths. That is, both the first side plate assembly 2 and the second side plate assembly 3 are rotated to be flush with the back plate 1 to reduce the space occupied by the wall-mounted shelf. Similarly, it is equivalent to completely avoiding the occupation of space for the installation space 40 of the wall-mounted shelf, there is no need for a complicated subsequent assembly process, and it is only needed to rotate the first side plate assembly 2 and the second side plate assembly 3 to assemble the wall-mounted shelf.

Preferably, the fully articulated extendable wall-mounted shelf further includes first connectors 23 and second connectors 33. In some embodiments, the first connectors 23 and the second connectors 33 can be, but not limited to, structures including screws and nuts, which are convenient for adjustment and assembly. The first connecting plate 20 and the first extendable plate 21 are each provided with first through slots 201. The first connectors 23 pass through the first through slots 201 and are configured to fix the first connecting plate 20 and the first extendable plate 21. In some embodiments, screws penetrate through the first extendable plate 21 and the first connecting plate 20 from one side and are connected with nuts, and the second extendable plate 21 and the second connecting plate 20 are fixed by tightening the screws and the nuts. Likewise, during the extendable adjustment process, the first connector 23 is equivalent to having a certain guiding effect. The second connecting plate and the second extendable plate are each provided with second through slots; the second connectors pass through the second through slots and are configured to fix the second connecting plate and the second extendable plate. In some embodiments, screws penetrate through the second extendable plate 31 and the second connecting plate 30 from one side and are connected with nuts, and the second extendable plate 31 and the second connecting plate 30 are fixed by tightening the screws and nuts. Likewise, during the extendable adjustment process, the second connector 33 is equivalent to having a certain guiding effect.

In some embodiments, a plurality of first through slots 201 are formed in parallel in both the first connecting plate 20 and the first extendable plate 21. A plurality of second through slots 301 are formed in parallel in both the second connecting plate 30 and the second extendable plate 31. The plurality of first through slots 201 and the plurality of second through slots 301 are formed to assemble the first connectors 20 and the second connectors 30 at different heights, thereby improving the fixing effect between the first extendable plate 21 and the first connecting plate 20 and between the second extendable plate 31 and the second connecting plate 30 and improving the structural stability.

In the use of the wall-mounted shelf, the first extendable plate 21 can be adjusted extendably relative to the first connecting plate 20, and the second extendable plate 31 can be adjusted extendably relative to the second connecting plate 30. That is, the height of the wall-mounted shelf is adjustable. Therefore, the wall-mounted shelf can be used for installing network devices of different depths such as distribution frames and switches, thereby having a wide application scope. The overall structure of the wall-mounted shelf is also very simple. During the installation of the network devices such as distribution frames and switches, the first fixing plate 22 and/or the second fixing plate 32 can be opened first, so that the network devices such as distribution frames and switches can be placed in the installation space 40 to prevent interference.

After the network devices such as distribution frames and switches are installed, the size of the installation space 40 is adjusted to realize adaption. The first connectors 23 and the second connectors 33 are used to respectively fix the first extendable plate 21 and the first connecting plate 20, fix the second extendable plate 31 and the second connecting plate 30. Then, the first fixing plate 22 and the second fixing plate 33 are closed, and the network devices such as distribution frames and switches are respectively fixed in the second fixing holes 220 and the third fixing holes 320. In this way, the installation process is simple and convenient. The extendable adjustment process is equivalent to stepless adjustment. That is, the wall-mounted shelf has an adjustable height and can be used to install network devices of different depths such as distribution frames and switches. Therefore, the wall-mounted shelf has a wide application scope.

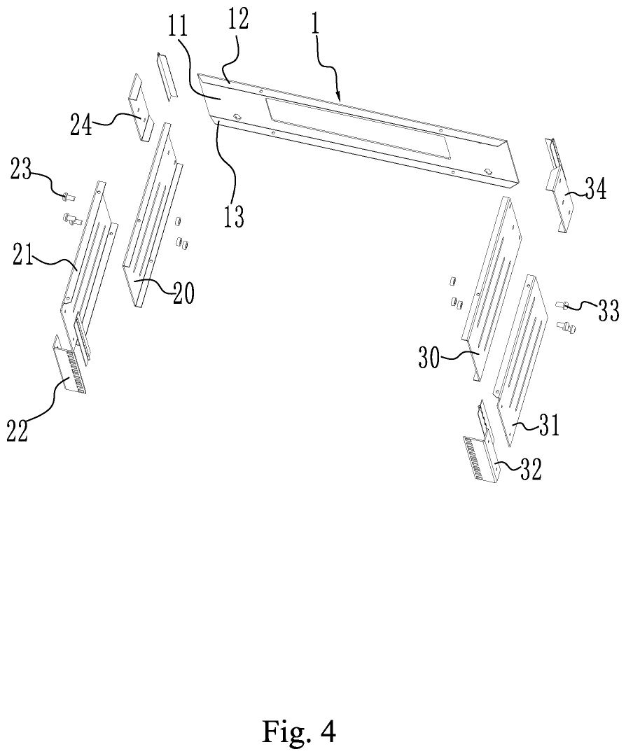

Referring to FIG. 4, each of the back plate 1, the first connecting plate 20, the second connecting plate 30, the third connecting plate 24, the fourth connecting plate 34, the first extendable plate 21 and the second extendable plate 31 includes a middle plate 11, an upper bent plate 12 and a lower bent plate 13, wherein the upper bent plate 12 and the lower bent plate 13 are respectively connected to the top and bottom of the middle plate 11. The back plate 1, the first connecting plate 20, the second connecting plate 30, the third connecting plate 24, the fourth connecting plate 34, the first extendable plate 21 and the second extendable plate 31 are all configured to comprise a middle plate 11, an upper bent plate 12 and a lower bent plate 13. In this way, the structural strength of each component is enhanced, and the overall structural strength of the wall-mounted shelf is also improved further. The upper bent plate 12 and the lower bent plate 13 also have a limiting effect.

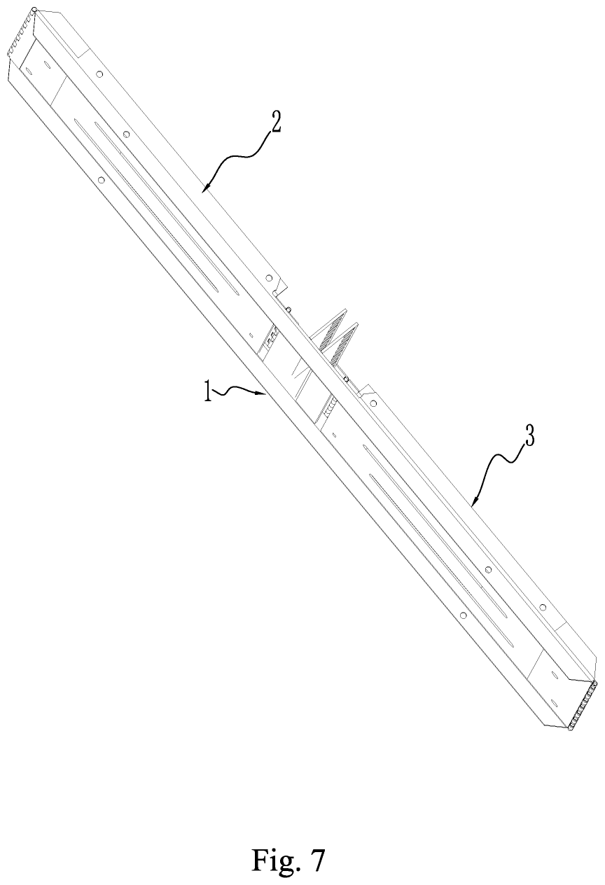

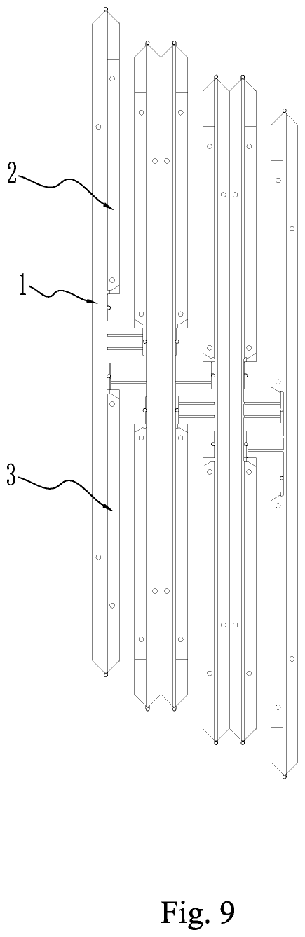

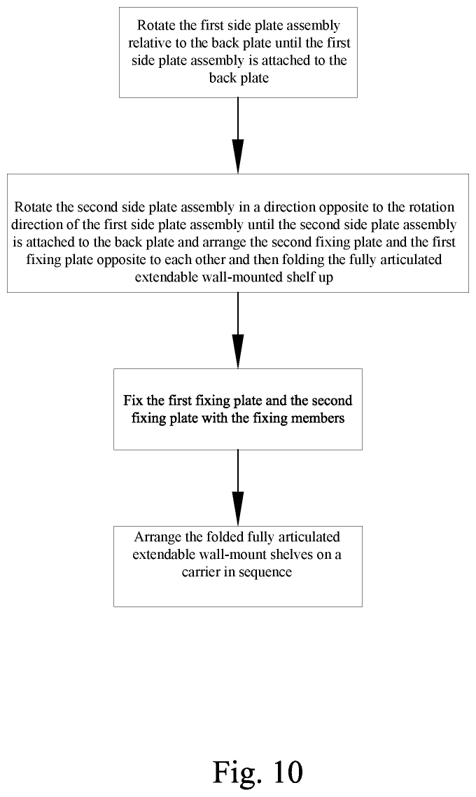

Referring to FIGS. 7-10, according to the present invention, illustrated is a method for transmitting the fully articulated extendable wall-mounted shelf, including fixing members and the fully articulated extendable wall-mounted shelf. The method for transmitting the fully articulated extendable wall-mounted shelf includes: rotating the first side plate assembly 2 relative to the back plate 1 until the first side plate assembly 2 is attached to the back plate 1;
rotating the second side plate assembly 3 in a direction opposite to the rotation direction of the first side plate 2 assembly until the second side plate assembly 3 is attached to the back plate 1 and arranging the second fixing plate 32 and the first fixing plate 22 opposite to each other and then folding the fully articulated extendable wall-mounted shelf up;
fixing the first fixing plate 22 and the second fixing plate 32 with the fixing members; and
arranging the folded fully articulated extendable wall-mount shelves on a carrier in sequence.

In some embodiments, the first fixing plate 22 is provided with a plurality of second fixing holes 220 sequentially from top to bottom, and the second fixing plate 32 is provided with a plurality of third fixing holes 320 sequentially from top to bottom. When both the first side plate assembly 2 and the second side plate assembly 3 are rotated to be attached to the back plate 1, the second fixing holes 220 and the third fixing holes 320 are arranged in one-to-one correspondence. Therefore, the first fixing plate 22 and the second fixing plate 32 are fixed by cable ties, bolts, or the like passing through the second fixing holes 220 and the third fixing holes 320; and then the whole wall-mounted shelf is fixed and hardly deformed, thus achieving high stability during transportation. Moreover, after the foldable wall-mounted shelf is transported to a customer, there is no need for a complicated subsequent assembly process, and it is only needed to rotate the first side plate assembly 2 and the second side plate assembly 3 to assemble the wall-mounted shelf.

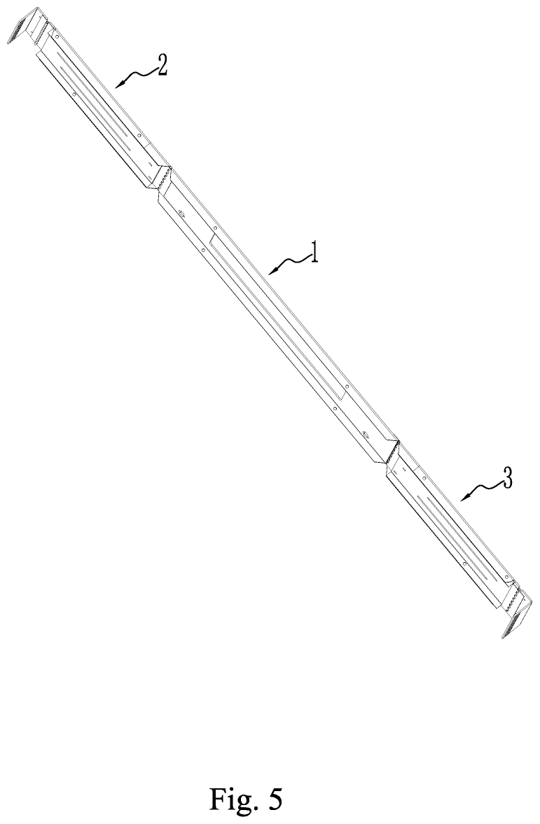

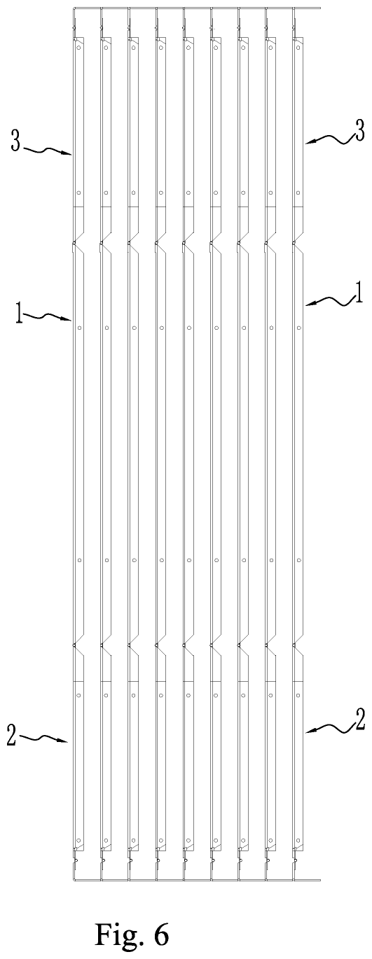

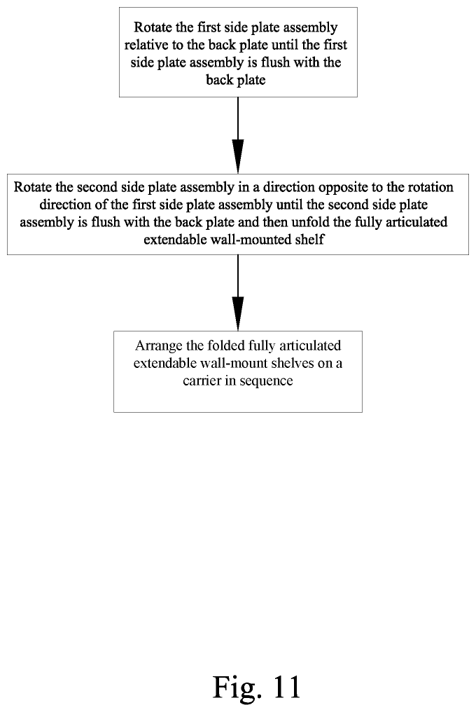

Referring to FIGS. 5-6 and FIG. 11, according to the present invention, illustrated is another method for transmitting the fully articulated extendable wall-mounted shelf, including the fully articulated extendable wall-mounted shelf. The method for transmitting the fully articulated extendable wall-mounted shelf includes:
rotating the first side plate assembly 2 relative to the back plate 1 until the first side plate assembly 2 is flush with the back plate 1;
rotating the second side plate assembly 3 in a direction opposite to the rotation direction of the first side plate assembly 2 until the second side plate assembly 3 is flush with the back plate 1 and then unfolding the fully articulated extendable wall-mounted shelf; and arranging the unfolded fully articulated extendable wall-mount shelves on a carrier in sequence.

Compared with the folding transportation, the unfolding transportation can be adopted for freight cars of different widths.

In this solution, the “fully articulated” design facilitates the transportation of the wall-mounted shelf and reduces the occupation of space in a carrier. Both the first extendable plate 21 and the second extendable plate 31 can be adjusted extendably to adjust the depth of the wall-mounted shelf so that the wall-mounted shelf can adapt to network devices of different depths such as distribution frames and switches. Therefore, the wall-mounted shelf has a wide application scope.

The specific embodiments described herein are only examples to illustrate the spirit of the present invention. Those skilled in the art to which the present invention belongs can make various modifications or additions to the specific embodiments described or use similar alternatives, without departing from the spirit of the present invention or going beyond the scope defined in the appended claims.

1. A fully articulated extendable wall-mounted shelf, comprising:
a back plate provided with a plurality of first fixing holes;
a first side plate assembly articulated at one end of the back plate and capable of rotating relative to the back plate to be flush with and/or attached to the back plate, the first side plate assembly comprising a first connecting plate, a first extendable plate and a first fixing plate that are arranged in sequence, the first extendable plate being arranged on the first connecting plate and capable of being adjusted extendably relative to the first connecting plate, the first fixing plate being rotatably connected to the first connecting plate and located at an end away from the first connecting plate; and
a second side plate assembly articulated at the other end of the back plate, and capable of rotating relative to the back plate to be flush with and/or attached to the back plate, the rotation direction of the second side plate assembly being opposite to the rotation direction of the first side plate, the second side plate assembly, the first side plate assembly and the back plate defining an installation space, the second side plate assembly including a second connecting plate, a second extendable plate and a second fixing plate that are arranged in sequence, the second extendable plate being arranged on the second connecting plate and capable of being adjusted extendably relative to the second connecting plate, the second fixing plate being rotatably connected to the second connecting plate and located at an end away from the second connecting plate.

2. The fully articulated extendable wall-mounted shelf according to claim 1, further comprising first connectors and second connectors, wherein
the first connecting plate and the first extendable plate are each provided with first through slots; the first connectors pass through the first through slots and are configured to fix the first connecting plate and the first extendable plate;
the second connecting plate and the second extendable plate are each provided with second through slots; the second connectors pass through the second through slots and are configured to fix the second connecting plate and the second extendable plate.

3. The fully articulated extendable wall-mounted shelf according to claim 2, wherein a plurality of first through slots are formed in parallel in both the first connecting plate and the first extendable plate; a plurality of second through slots are formed in parallel in both the second connecting plate and the second extendable plate.

4. The fully articulated extendable wall-mounted shelf according to claim 1, wherein the first side plate assembly further comprises a third connecting plate, and the second side plate assembly further comprises a fourth connecting plate; the third connecting plate is arranged between the back plate and the first connecting plate; the fourth connecting plate is arranged between the back plate and the second connecting plate;
wherein each of the back plate, the first connecting plate, the second connecting plate, the third connecting plate, the fourth connecting plate, the first extendable plate and the second extendable plate includes a middle plate, an upper bent plate and a lower bent plate, wherein the upper bent plate and the lower bent plate are respectively connected to a top and a bottom of the middle plate.

5. The fully articulated extendable wall-mounted shelf according to claim 4, wherein the first fixing plate is provided with a plurality of second fixing holes sequentially from top to bottom, and the second fixing plate is provided with a plurality of third fixing holes sequentially from top to bottom;
when both the first side plate assembly and the second side plate assembly are rotated to be attached to the back plate, the second fixing holes and the third fixing holes are arranged in one-to-one correspondence.

6. The fully articulated extendable wall-mounted shelf according to claim 4, wherein the third connecting plate is fitted over the first connecting plate and detachably connected with the first connecting plate, and the first extendable plate is movably fitted over the first connecting plate;
the fourth connecting plate is fitted over the second connecting plate and detachably connected with the second connecting plate, and the first extendable plate is movably fitted over the second connecting plate.

7. The fully articulated extendable wall-mounted shelf according to claim 1, wherein the first fixing hole comprises a round hole and a waist-shaped hole penetrating through the round hole, and a diameter of the round hole is greater than a width of the waist-shaped hole.

8. The fully articulated extendable wall-mounted shelf according to claim 1, wherein the first side plate assembly and the second side plate assembly are symmetrically connected to two ends of the back plate, and the first side plate assembly and the second side plate assembly are the same in structure.

9. A method for transporting a fully articulated extendable wall-mounted shelf, comprising fixing members and the fully articulated extendable wall-mounted shelf according to claim 1, the method for transporting a fully articulated extendable wall-mounted shelf including:
rotating the first side plate assembly relative to the back plate until the first side plate assembly is attached to the back plate;
rotating the second side plate assembly in a direction opposite to the rotation direction of the first side plate assembly until the second side plate assembly is attached to the back plate and arranging the second fixing plate and the first fixing plate opposite to each other and then folding the fully articulated extendable wall-mounted shelf up;
fixing the first fixing plate and the second fixing plate with the fixing members; and
arranging the folded fully articulated extendable wall-mount shelves on a carrier in sequence.

10. A method for transporting a fully articulated extendable wall-mounted shelf, comprising the fully articulated extendable wall-mounted shelf according to claim 1, the method for transporting a fully articulated extendable wall-mounted shelf comprising:
rotating the first side plate assembly relative to the back plate until the first side plate assembly is flush with the back plate;
rotating the second side plate assembly in a direction opposite to the rotation direction of the first side plate assembly until the second side plate assembly is flush with the back plate and then unfolding the fully articulated extendable wall-mounted shelf; and
arranging the unfolded fully articulated extendable wall-mount shelves on a carrier in sequence.
